(19) United States
(12) Patent Application Publication
(10) Pub. No.: US 2009/0132263 A1
(43) Pub. Date: May 21, 2009

(54) Residential Race Course

(75) Inventor: Patrick Costello, Breckenridge, CO (US)

Correspondence Address: FISH & RICHARDSON P.C., PO BOX 1022, MINNEAPOLIS, MN, 55440-1022, US

(73) Assignee: UNLIMITED SPEED, LTD., Breckenridge, CO (US)

(21) Appl. No.: 11/913,011

(22) PCT Filed: Apr. 27, 2006
(86) PCT No.: PCT/US06/16460

§ 371 Date: Oct. 29, 2007

Related U.S. Application Data
(60) Provisional application No. 60/675,236, filed on Apr. 27, 2005.

(51) Int. Cl. G06Q 10/00

(52) U.S. Cl. 705/1

(57) ABSTRACT

A private development is described. It includes at least two residences each located on a separate parcel of private land. The residences are owned by different residents. The development also includes a private automobile racetrack. The private automobile racetrack is at least partially surrounded by each parcel of private land, and the private automobile racetrack is fractionally owned by the residents. The development includes a ingress and egress between the residences and the private automobile racetrack.

### TECHNICAL FIELD

This specification relates to a residential racecourse.

### BACKGROUND

In the 1940s, suburban neighborhood developments were created, capturing a new residential lifestyle away from the hustle and bustle of city life. Since then, lifestyle developments have become a highly profitable niche in suburban development. Catering to specific interests, like golf, hunting and fishing, lake and oceanside, retirement, and even aviation developments have captured a lifestyle by focusing on unique hobbies and interests. To conveniently engage your passion, and to live with and next to like-minded people elevate the quality of life. In today's ever-increasing chaotic world, the added factors of privacy, security, and anonymity cannot be discounted.

The automobile has inarguably been one of mankind's greatest achievements. It has always been a symbol of independence, freedom, and adventure. Love of the automobile is almost universally understood. Motor sports is one of the world's largest industries. Literally hundreds of billions of dollars are made from and spent on motor sports each year. It is estimated as much as $10 billion is spent annually on Formula One racing alone. Michael Schuemacher, a driver for Ferrari, is the world's wealthiest athlete, earning more than $80 million per year. Successful NASCAR and champ car drivers earn between $5 and $9 million dollars per year. Amassing a huge fortune from a successful motor sports career has become typical.

What options are available to the auto enthusiast? There are billions of dollars invested in car collections housed in garages and warehouses across America. Because of the inconvenience factor, these thoroughbreds infrequently have the opportunity to stretch their legs. To rent track time and trailer a car or two to some remote location is about the only way to really put a sports car through the paces. Some motor sport clubs permit members to transport their cars to the club's grounds and rent track time for racing. To register and plate street legal cars is another, more convenient, but depressingly limited option.

### SUMMARY

In general, the specification describes a residential development that incorporates a racetrack.

In one aspect, a private development is described. It includes at least two residences each located on a separate parcel of private land. The residences are owned by different residents. The development also includes a private automobile racetrack. The private automobile racetrack is at least partially surrounded by each parcel of private land, and the private automobile racetrack is fractionally owned by the residents. The development includes an ingress and egress between the residences and the private automobile racetrack.

In a second aspect, a method for developing a community is described. The method includes providing private housing on private land. The private housing includes at least two residences, each of which is owned by different residents. The method also includes providing a private automobile racetrack. The private automobile racetrack is at least partially surrounded by the private land, and the private automobile racetrack is not publicly accessible. The method includes providing an access way from the private housing to the private automobile racetrack.

In a third aspect, a method for operating an automobile racetrack is described. The method includes providing a private automobile racetrack, and selling parcels of land surrounding the private automobile racetrack. Private residences are built on the parcels of land. The method also includes fractionally dividing ownership of the private automobile racetrack between owners of the private residences.

The systems and techniques described here may provide one or more of the following advantages. First, access to residential racetrack systems may provide racecar enthusiasts convenient locations to enjoy their hobby. Second, the private nature of residential racetrack systems may afford residents with privacy not available at publicly accessible racetracks. Third, racetrack systems may facilitate dual uses, such as the racetrack may double as a landing strip for private airplanes. Fourth, racetrack systems may reduce noise from racetracks using paddocks and trees.

The details of one or more embodiments are set forth in the accompanying drawings and the description below. Other features and advantages of the described embodiments will be apparent from the description and drawings, and from the claims.

### DESCRIPTION OF DRAWINGS

FIG. 1 is a diagram of one embodiment depicting a large-scale time-share condo development.

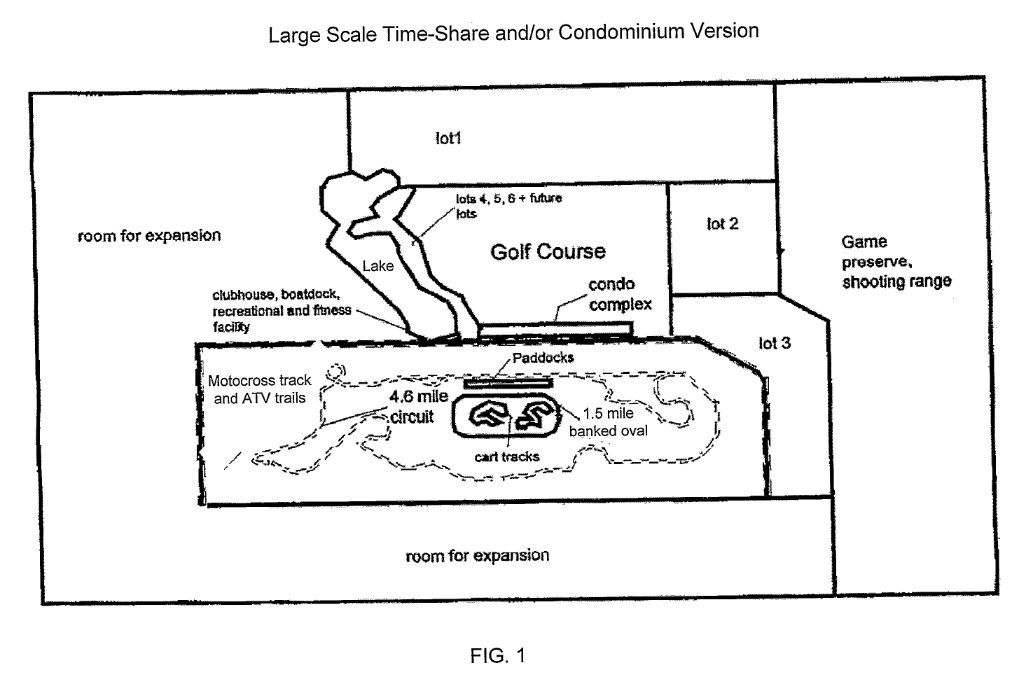

FIG. 2 is a diagram of another embodiment depicting a single-family housing development.

FIG. 3 is a diagram of an embodiment depicting a first residential development.

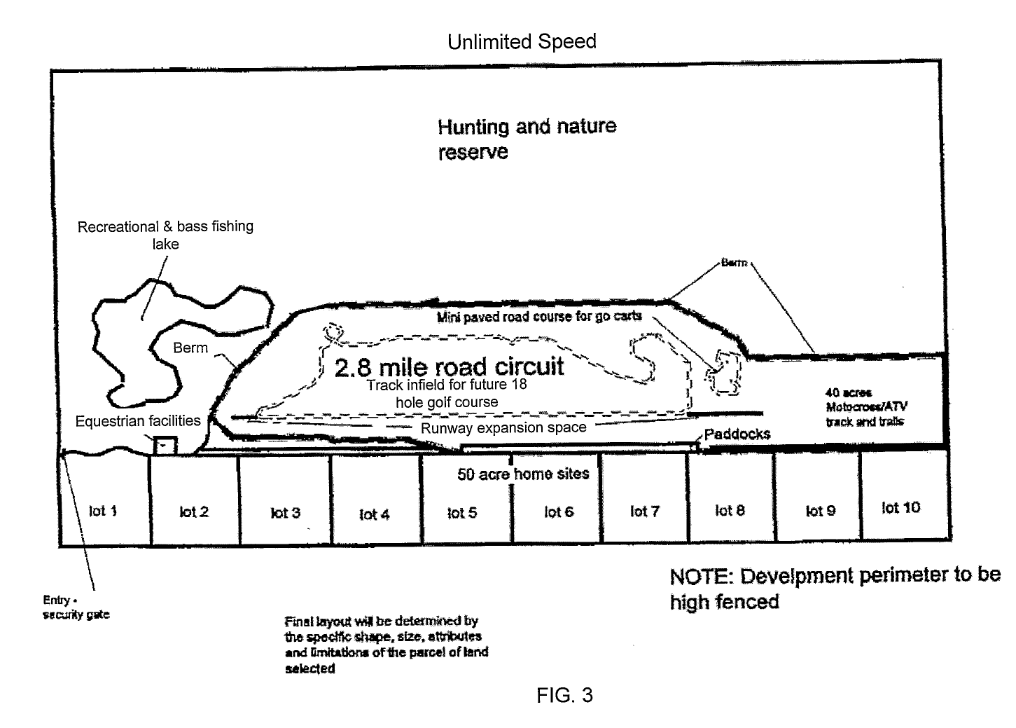

FIG. 4 is a diagram of an embodiment depicting a second residential development.

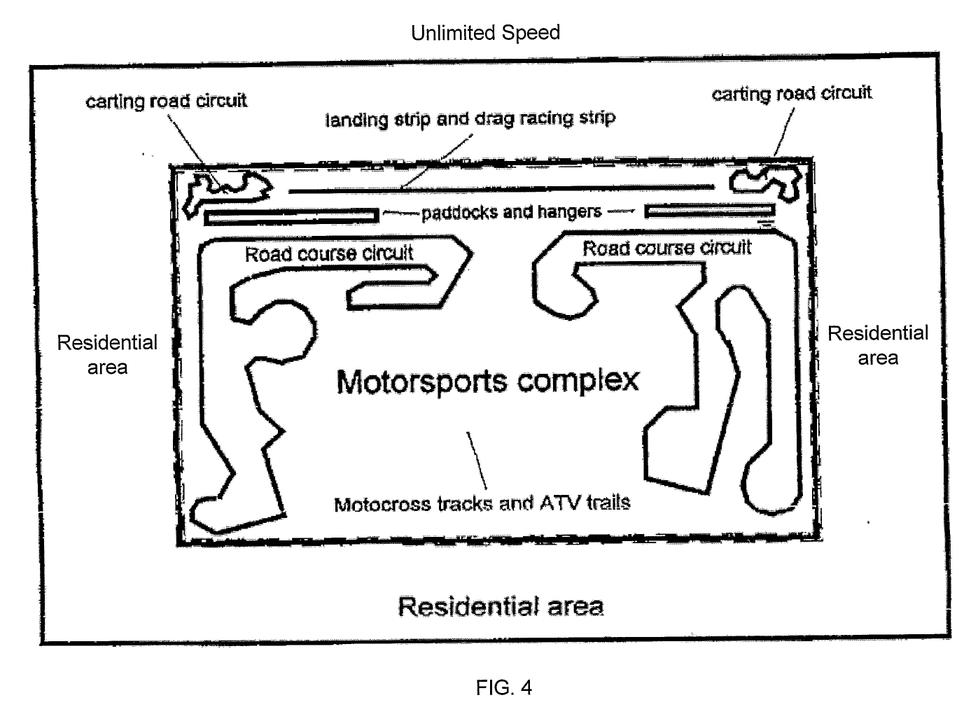

FIG. 5 is a diagram of an embodiment depicting a third residential development.

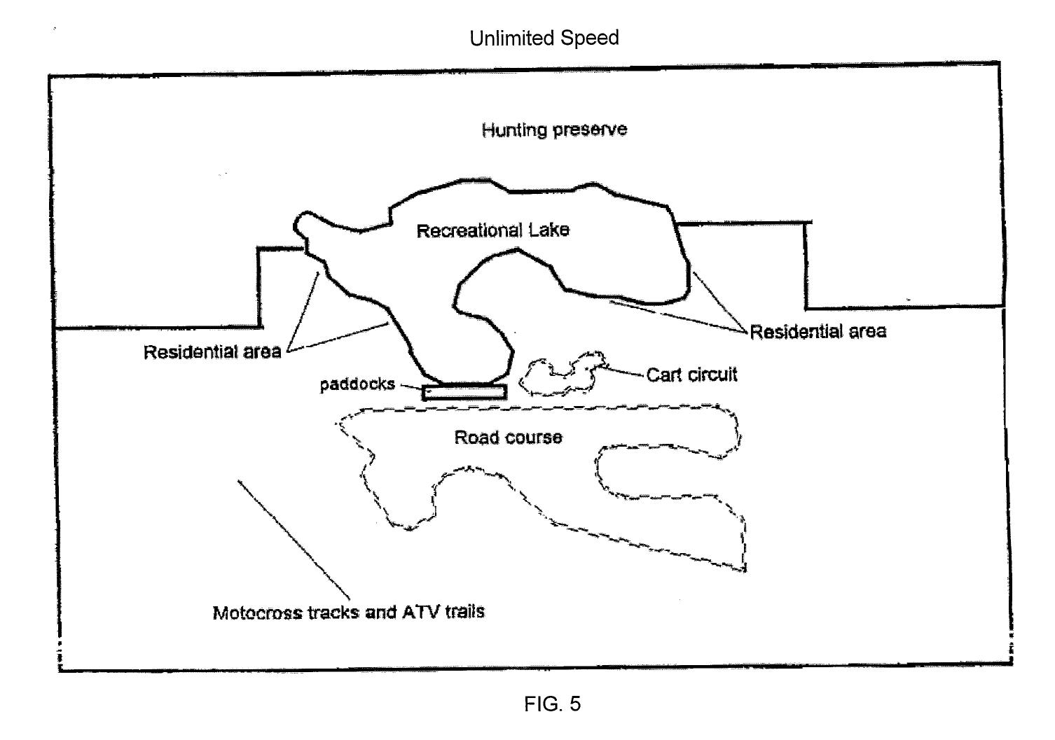

FIG. 6 is a diagram of an embodiment depicting a fourth residential development.

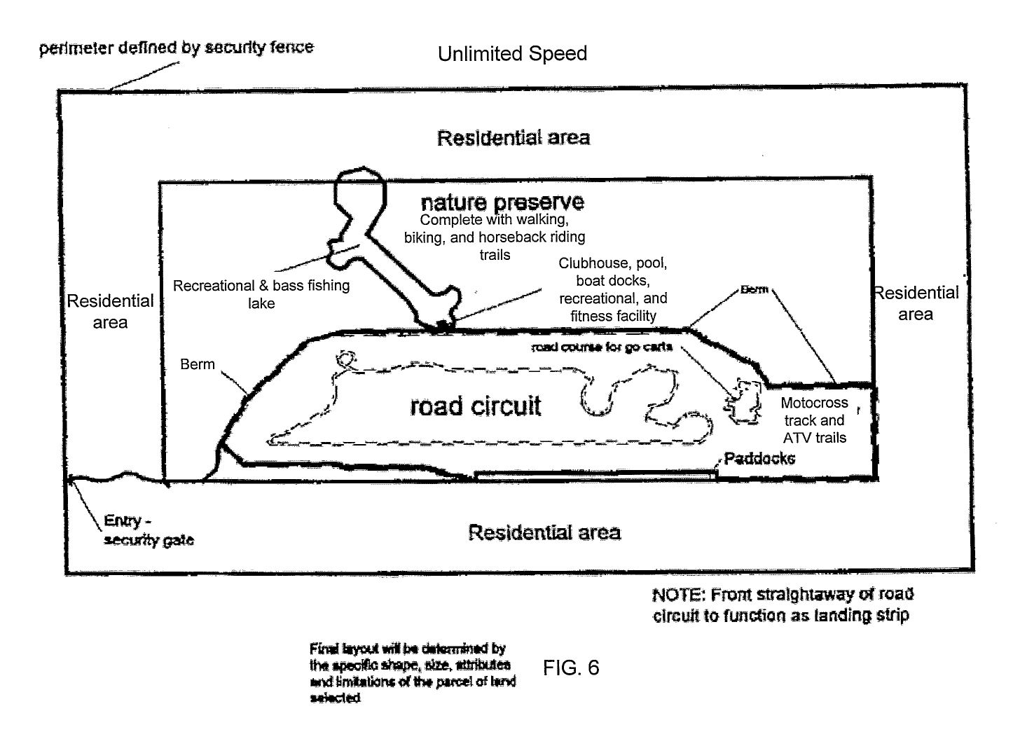

FIG. 7 is a diagram of an embodiment depicting a fifth residential development.

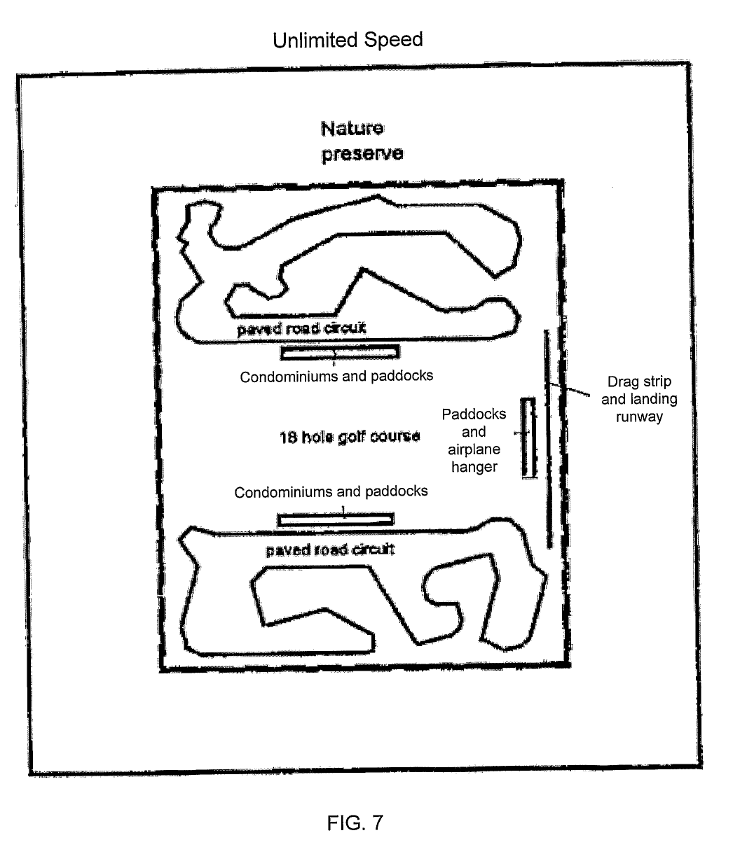

FIG. 8 is a diagram of an embodiment depicting a sixth residential development.

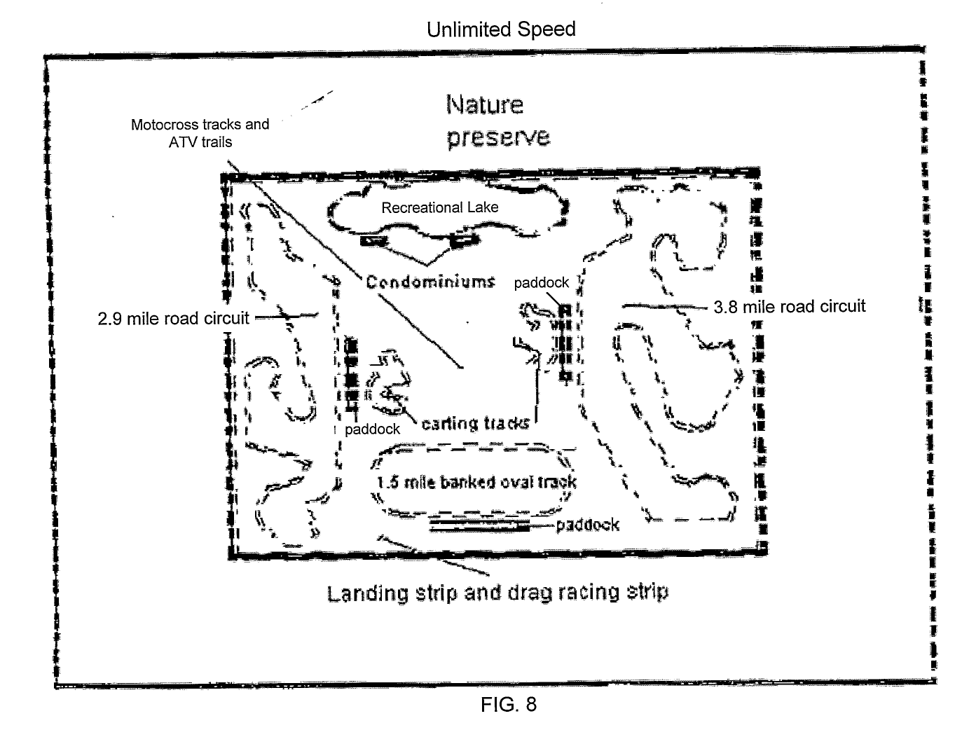

FIG. 9 is a diagram of an embodiment depicting a seventh residential development.

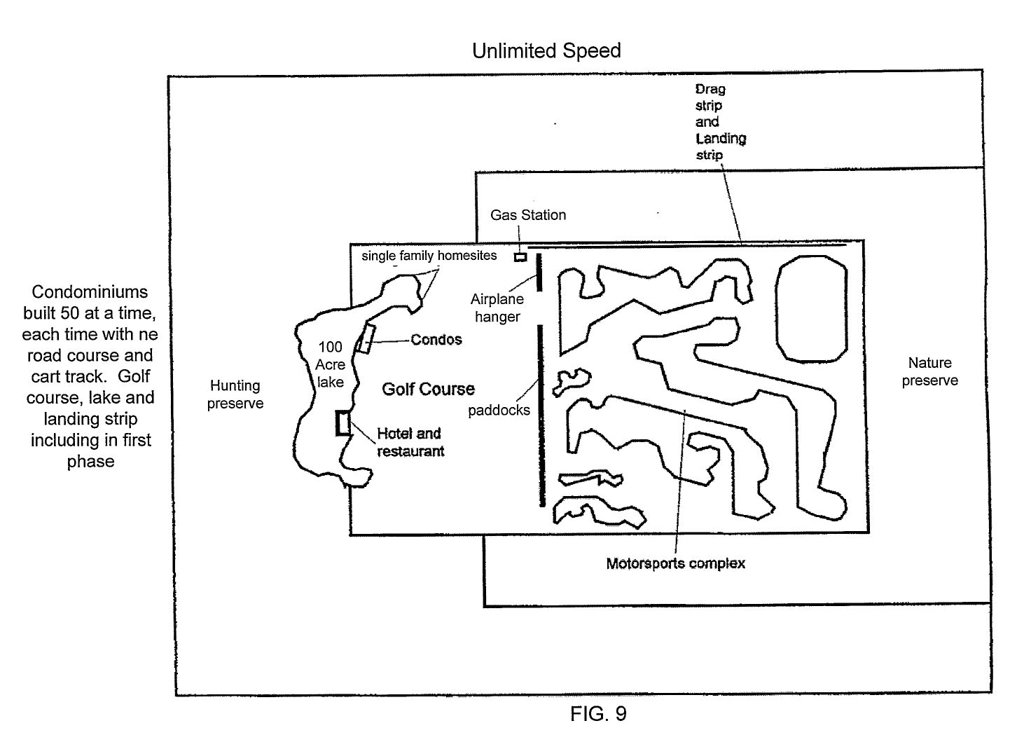

FIG. 10 is a diagram of an embodiment depicting an eighth residential development.

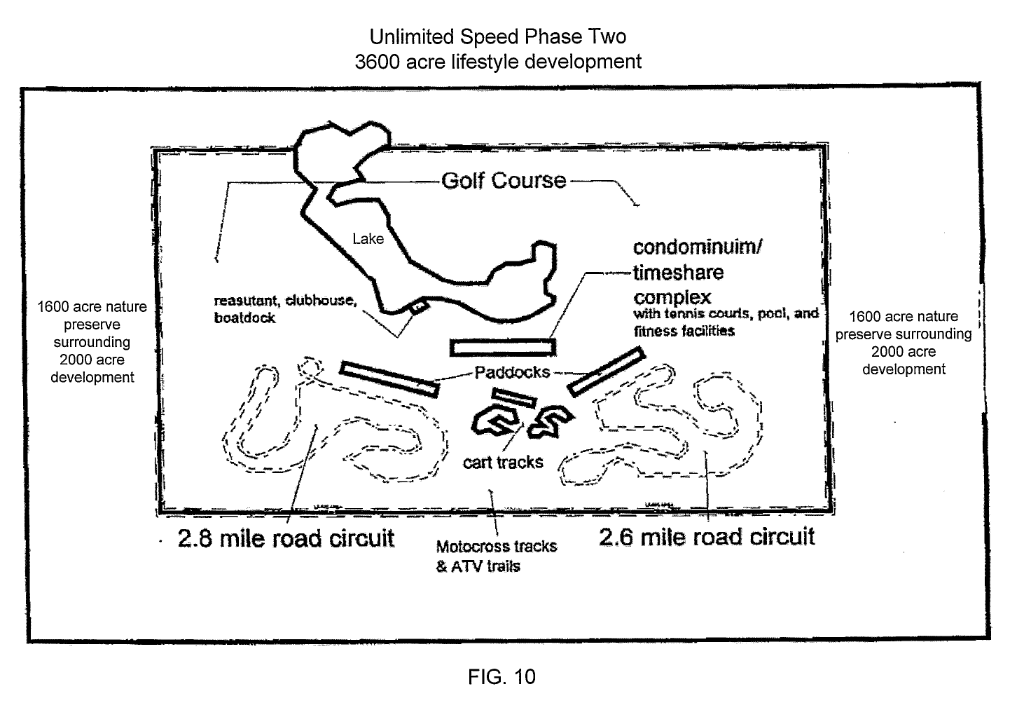

FIG. 11 is a diagram of an embodiment depicting a ninth residential development.

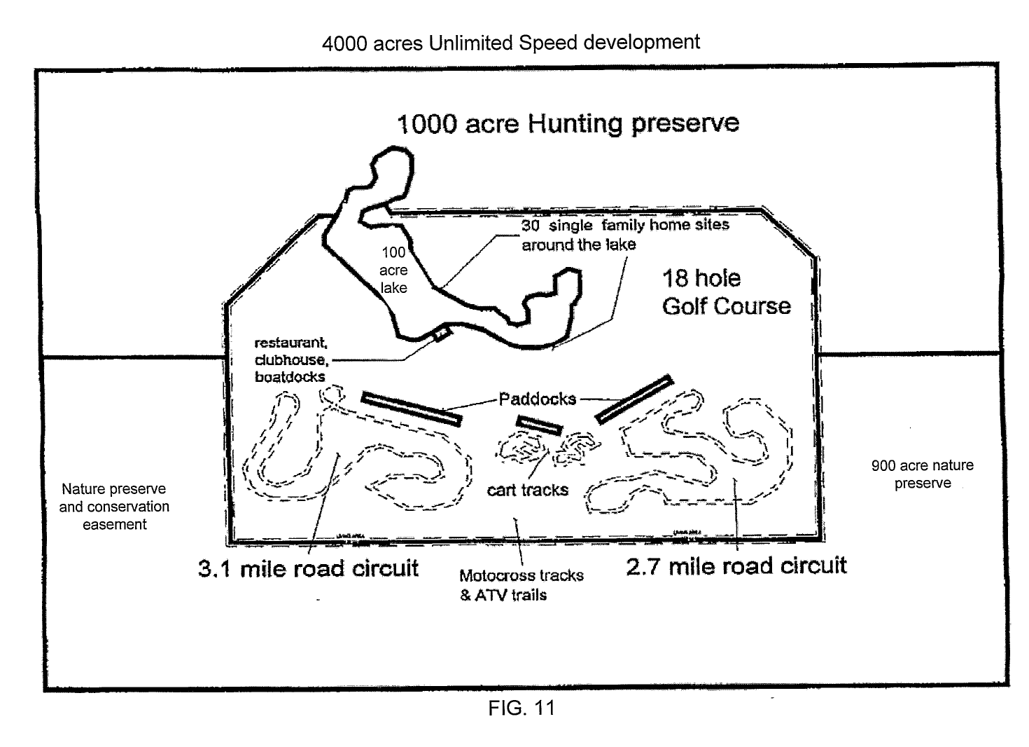

Like reference symbols in the various drawings indicate like elements.

### DETAILED DESCRIPTION

In certain embodiments, Unlimited Speed is a lifestyle development consisting of no less than 2000 acres of land, limited to 8 exclusive home sites. For this embodiment, each of the 8 home sites can be approximately 100 acres, with the remaining 1200 acres owned ⅛ each, and maintained by a homeowner's association. The 1200 acres jointly owned and maintained by the association can be land locked centrally between the 8 homestead estates. The heart of the development is its motor sports pedigree, featuring a world-class formula one style road course.

In one embodiment, the road course circuit can be approximately 2.8 miles in length, and can incorporate between 8 and 10 turns. The layout and number of turns can ultimately be determined by the property. The course may be designed by professional racetrack designers. The road course may be created with safe run off areas to minimize danger and prevent risk to valuable cars. It may incorporate a front straightaway of approximately 5300 feet, oriented into the prevailing winds in order to double as a private landing strip for the homeowners. The length of this straightaway may be determined to accommodate landing and take off of even large private jets. In one embodiment, adjacent to this front straightaway may be 8 two-acre parcels. Each two-acre parcel may be owned individually and included in the purchase price of a home site. The parcels may be designed to accommodate a paddock area to house the car collection and airplanes of each individual owner. The development also may include a 0.4 mile carting road course, a recreational lake for fishing, water skiing, and jet skiing, motocross and ATV track and trails, an equestrian facility, and a 700 acre nature preserve for hiking, biking, camping, and horseback riding. The lake may be stocked with trophy bass, and features an over water clubhouse with kitchen and bathroom, bar, fitness facilities, pool, decks, and boat garages. The equestrian facilities can offer indoor amenities including a riding arena, stalls, tack room, kitchen, and bathroom.

The entire development can be fenced and protected by security guards 24 hours a day, 365 days a year. Old-growth trees may provide visual coverage and private access roads may be present for each homestead. Finn anonymity policies may be present for owners and guests, and restricted media guidelines and procedures may be implemented. Additionally, the paddock facilities, homes, and property may be monitored remotely using cameras hooked up to a network, such as the internet. Owners may log on to a web portal to view their property in real time.

The development can begin with a selection of a parcel of land. Geographic conditions and site-specific attributes may dictate certain constraints necessary for the success of the development. The development may be located in the southeastern United States in the heart of motor sports country. Its location may not be too far north, in order to limit pavement maintenance and to facilitate comfortable and convenient year-round use of the track. The development may be located within a 30-minute drive of at least a medium size town. It is important that convenience to the investors is incorporated into every decision, and therefore easy access to restaurants and shopping is a prerequisite. In one embodiment, the parcel of land consists of a contiguous block of land. Furthermore, the land may be tree covered for privacy, as well as to reduce and contain noise generated from the road course. In one embodiment, the development is not in the flight path of any regional airports, which may infringe on air travel to and from the property.

In the embodiment in which the development is limited to eight owners, the development maximizes privacy and eliminates competition for track time and associated inconvenience. This exclusivity ensures safety, security, and anonymity. It may also afford each of the 8 investors approximately 100 private acres to pursue additional interests, for example, equestrian pursuits. To be able to fly in, and for family members to horseback ride, fish, and water ski within the constraints of this private, secure, and guarded setting while at home is a unique offering. For someone with millions of dollars invested in a car collection, or the professional racecar driver who wants to maintain his skills at home and teach his children to race or for any motor sports enthusiast valuing privacy, security, convenience, and anonymity, the development may provide a solution.

The process of creating the development may consist of several stages including:

Letter of intent on land/permitting approvals;

Marketing;

Survey- re-zone and subdivide;

Clear trees where required and generate access;

Trench infrastructure to paddocks area;

Grade for track, dig lake;

Pave track, build club house, and equestrian facilities;

Build homes and individual paddocks to individuals' desired specifications.

The process of creating the development is described in greater detail below.

Stage One—Secure Letter of Intent on Land/Permitting Approval

Agriculturally zoned land in the southeast may be acquired. The land may be treed for privacy, not in the flight path of close airports, within 30-minute drive of food and shopping, with a minimum of hills, and offer a rectangular core of no less than 2000 acres. The orientation of the parcel must accommodate a 6600-foot runway into the prevailing winds. Closing can occur following completion of all feasibility requirements, including noise testing and associated analysis for local noise ordinance compliance, local government planning and zoning approvals, FAA regulations and approval, utility availability and feasibility, availability of adequate access, soils testing, topographical maps, etc.

Stage Two—Marketing

As soon as feasibility is completed, a high-end and discreet marketing campaign begins. Artists rendering, professional glossy brochures, and even travel for perspective buyers may be provided. A full price escrow may be required from prospective buyers until closing occurs.

Stage Three—Survey & Subdivide

The eight individual parcels can be stalked, including boundaries, access, and building envelopes. The association land, paddock, track, equestrian facilities, and lake can be staked. Two surveyors at $60/hr each, for a total of 250 hours, plus topographical maps, plus expenses, will cost $25,000. As soon as the first parcel sells an added $30,000 legal fees expense may arise. This is to establish Victory Lane homeowners association and generate association covenants, as well as create sign off insurance and liability waivers for otherwise impermissible guests of owners.

Home Owners Association

The Victory Lane homeowners association LLC can be set up and funded by the developer with $2,000,000. This nest egg is designed to all but eliminate the need for expensive association fees. The development is built to ensure anonymity, privacy, and security. The association can have a full time maintenance man and groundskeeper, as well as security guards on site 24 hours a day, seven days a week as soon as the first home has been started. The groundskeeper and maintenance man can be responsible for day-to-day upkeep, as well as function as spotters and safety observers when the track is in use. The track can be red flagged before and after airplane takeoffs and landings for a specified time. Security can red light and red flag the track for outgoing flights or for airphone requests for authorized landings. At least one staff member with emergency medical training can be on site at all times. Track amenities include a transport suburban, road sweeper, and fire truck for added safety. Security guards (in shifts of two) can patrol the grounds 24 hours a day, 7 days a week to protect all assets and more importantly, privacy and security. Each residence and paddock can have a direct link to security at all times. All contractors, employees, etc. can be required to sign confidentiality agreements to ensure anonymity. The maintenance and security cost to the owners for the privilege of this plane-accessible development with complete security is minimal. Groundskeepers/spotters working 16 hours a day, 7 days a week, 50 weeks a year, generate an annual cost of $81,536 and Security (two officers) working 24 hours a day, 7 days a week, 52 weeks a year, generate an annual cost of $349,440. With additional miscellaneous expenses, the total estimated cost is $4500/month per owner for this private road course, lake, land and 24 hour security. Each owner also owns a ⅛ share of Victory Lane LLC; the value of the 1200 acres and related improvements, including the lake, clubhouse, equestrian facilities, nature preserve, carting track, road course, paddock, and landing strip, as well as $2,000,000 in cash accruing and available to find maintenance.

Stage Four—Clear Trees

Clearing all land for the track, associated run off areas, lake, paddock, and access as required, plus select cutting of valuable hard woods from the rest of the property can be performed. A lumber mill owner from SC estimates approximates revenue of $300,000 per 1000 acres of treed land for a select cut of hardwoods and pines. An estimate of $300,000 in revenue from 1000 clear cut and 1000 select cut is very conservative. After labor and machine expenses are accounted for, a net surplus of $225,000 may be generated. The revenue from the timber can help pay for power or other utilities or costs generated by ownership of the property.

Stage Five—Trench Utilities to Paddock

The paddock call house a central distribution network for power to supply the development. A cost estimate of $600,000 and a budget estimate of $375,000 have been applied assuming a one-mile underground run, and up to 3 miles of overhead, and including any necessary transformer equipment. Power distribution and security interfaces to each home and paddock can coincide with related improvements.

Stage Six—Grade for Track While Digging Lake

One objective is to create a world-class track, so controlling grade and being able to alter it may be important. The lake can be approximately 50 surface acres and 10-15 feet deep. Creating the lake may displace approximately 700,000 yards of fill, at a cost of approximately $1,850,000. The lake can be designed for fishing, Jet Skiing, and water-skiing. The fill from the lack can be used for manipulating grade and drainage around the track. To create a safety and noise abatement berm around the track, and strip topsoil for track preparation may cost an additional $290,000.

Stage Seven—Pave Track and Paddock Row, Build Clubhouse and Equestrian Facilities

The track complex can consist of 696,000 square feet of paved surface. This includes 644,550 square feet of track, at 2.8 miles long, and an average of 35 feet wide. The front straightaway can be 5300 feet long by 60 feet wide, with room for expansion to accommodate even the largest private jet, should an owner require it. Additional paving in front of paddock row is included in this analysis. The pavement can consist of PG82-22 asphalt, designed for and used to pave all new race complexes. This hot mix asphalt has an angular aggregate structure and polymer additive for durability and longevity. For cost analysis, specifications include 696,000 square feet of 8″ to 9″ of crushed granite compacted to 100% compaction, paving of 696,000 square feet with a 3″ binder lift of PG82-22, followed by a 2″ surface lift of PG82-22. Bids from two large road-building firms may range from $2,047,000 to $2,360,000. For budget purposes, an estimate of $2.6 million is appropriate. A 5000 square feet clubhouse can be built over the water at an estimated cost of $1.1 million. The equestrian complex featuring a 100 by 250 foot indoor facility may be estimated to cost $700,000.

Stage Eight—Build Homes and Paddocks

The developer can keep one lot, and can build the first paddock as soon as the track is completed. The paddock can consist of a one-acre steel building able to conceal an impressive army of cars and airplanes, plus a huge mezzanine for an overview, with a recreation area, an apartment, and an office. The developer can also write the architectural covenants and act as development review board.

The outlay of funds for the development may consist of several stages including:

Due diligence, develop Home Owners Association (HOA) guidelines, advertising;

Acquire land, surveying, and tree clearing;

Build track and lake, fund HOA;

The outlay of funds is described in more detail below.

The project may begin and end as a self-funded project, with a short-term need for land acquisition funding from an investor. Funding from an investor for property acquisition may require $2 million. Unlimited Speed has the resources to subdivide, survey and stake, clear, trench in infrastructure, begin construction on the lake, and market the property. Once the first lot is sold, construction can begin on the track. No funding beyond land acquisition may ever be required from the investor, who need not be concerned with his investment being spent wisely on improvements. The original price of a large, almost unattainable piece of land at fair market value that is then rezoned and improved, may increase the land's value. This limits exposure to the investor. Another benefit to investor is flexibility. Projections show investment can be refunded by the developer after the sale of the second lot, should the investor be so inclined. This means complete investor turnaround can occur 9 to 12 months after land purchase closing date.

In one embodiment, which may be called phase one, the development may cost $5 million for property acquisition, and $8.9 million for improvements, and the lots may sell for an average of $7.5 million. At $7.5 million for each lot, the gross proceeds would be $60 million. There are two choices for financing-self or investor-funded. It may take a minimum of a $1.4 million down payment, plus $600,000 of financing on the remaining $3.6 million, plus $900,000 for digging the lake, utilities, and marketing, for a total investment of $2.9 million. Because of low exposure profile and quick turn-around for the investor, a relatively low rate of return is appropriate. Land has historically been a great investment, and large parcels are becoming even more valuable with population growth, so investor risk is low. To acquire land that has been improved in this appreciating market, should something somehow not work out, is a worst-case scenario for the investor.

In an alternative embodiment, the concept works on a sliding scale. After completing the low density, high-end residential development, or phase 1, the proceeds generated can fund the second development phase. Phase 2 is an “everyman” version of the development. It allows a motor sport fan the opportunity to engage his or her passion for racing. The buyer profile may be a racing fan earning over $75,000 per year who owns one or more sports cars.

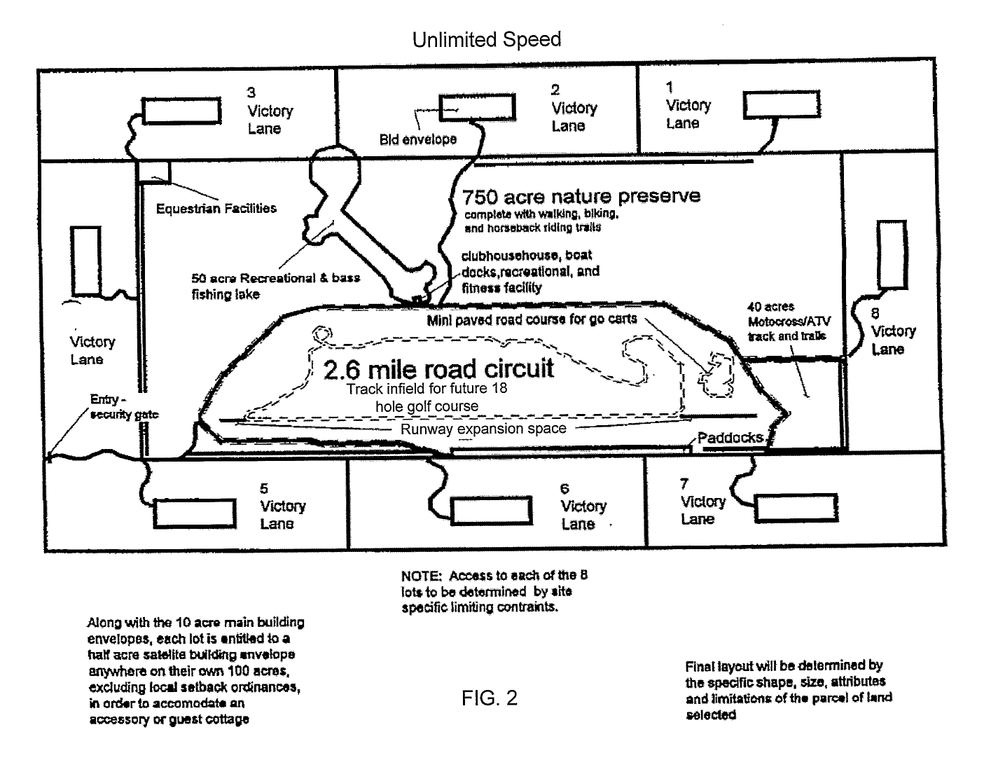

In phase 2, 3600-acres of contiguous land may be acquired. Phase 2 may include a 2000-acre motor sports lifestyle development with 1600-acre nature preserve buffer, which land locks the development to create privacy and mitigate any potential noise export to off-site. The 1600-acre buffer is intended to be dedicated as a nature Conservatory for related tax benefits and zoning consideration. The two road courses, two carting courses, paddocks, a one-hundred acre lake, a golf course, and a preserve are designed to support 100 fractional ownership condominiums. Each racetrack is structured to support 50 dwelling units (e.g. 3 tracks-150 units, 4 tracks-200 units). See FIG. 2. The development costs can include feasibility and permitting, land acquisition, construction of the condominium building, a golf course, a one-hundred acre lake, and a clubhouse (which may include a restaurant), tracks and paddocks, any infrastructure, setting up time-share and marketing, and sales commission.

The 100 condominiums are one and two bedroom, 600 and 750 square feet each, and sell for $34,000 and $46,000 per week, respectively. (This price structure may be comparable to ski area time-share during ski season in Colorado.) Each day these 100 owners get four half-hour sessions of road circuit, four half-hour sessions of car track, and paddock facility use, in groups of 10, at various assigned times from 8 a.m. to 6 p.m. There may be no night driving. Driving instructors can be available for professional instruction for a fee. Other amenities, such as lake for fishing, a restaurant and bar, pool and fitness facility, motor cross tracks in ATV trails, and a nature preserve for hiking and biking may be available. Use of the golf course, ski boats, fishing boats, and jet skis on a lake are available for a fee.

After phase 2 generates an anticipated profit, phase 3 may be implemented. Phase 3 includes the development described in phase 2 with an addition of two more racetracks, designed to support 200 drivers with four one-half hour sessions per day. Five thousand acres of land in a state, such as Texas may be acquired. Other costs may include the construction of the lake and clubhouse, a golf course, cost of the four tracks, a landing/drag racing strip, paddocks, and the construction of 100 condominium units, 100 hotel rooms, and the associated marketing and sales costs. The operations may function similar to those in phase 2 with additional income generated by the hotel. The hotel may be projected to meet expenses at a low percentage of occupancy with a skeleton staff during startup. At approximately 30% occupancy the hotel may be projected to generate a significant amount of yearly revenue, although it may generate income a lower percentage of occupancy.

In one embodiment, after selling the condos in phases 2 and 3, and getting the hotel described in phase 3 to profitable occupancy, the hotel, some or all of the developments may be sold.

In another embodiment, the developer may franchise or license the model to an outside developer or investor.

A number of various embodiments have been described. Nevertheless, it will be understood that various modifications may be made without departing from the spirit and scope of the described embodiments. For example, the development is not limited to eight homesteads, but may include nine homesteads, condominiums, a hotel, or combinations thereof. Accordingly, other embodiments are within the scope of the following claims.

What is claimed is:

1. A private development comprising:
at least two residences each located on a separate parcel of private land, wherein the residences are owned by different residents;
a private automobile racetrack comprising a paved track designed to accommodate high-speed driving of high performance automobiles, wherein the private automobile racetrack is at least partially surrounded by one or more of the parcels of the private land, and wherein the private automobile racetrack is fractionally owned by the residents; and
an ingress and egress between the residences and the private automobile racetrack.

2. The development of claim 1, further comprising paddocks located substantial near the automobile racetrack, wherein each paddock is owned separately by one of the different residents.

3. The development of claim 1, further comprising air traffic control equipment used to authorize air traffic take off and landings on the private automobile racetrack.

4. A method for developing a community, comprising:
providing private housing on private land, wherein the private housing comprises at least two residences, each of which is owned by a different resident;
providing a private automobile racetrack comprising a paved track designed to accommodate high-speed driving of high performance automobiles, wherein the private automobile racetrack is at least partially surrounded by a portion of the private land, and wherein the private automobile racetrack is not publicly accessible; and
providing an access way from the private housing to the private automobile racetrack.

5. The method of claim 4, further comprising providing private paddocks substantially near the private automobile racetrack, wherein one or more of the different residents own the private paddocks.

6. The method of claim 5, wherein the private paddocks are positioned to act as noise buffers between the private automobile racetrack and a portion of the private housing.

7. The method of claim 4, further comprising landing planes on the private automobile racetrack.

8. The method of claim 4, wherein the private automobile racetrack is fractionally owned by the residents.

9. The method of claim 8, wherein the residents have fractional ownership in a homeowners association, which owns the private automobile racetrack.

10. The method of claim 4, wherein the private land is not publicly accessible because the private land is part of a gated community.

11. The method of claim 4, further comprising providing an artificial lake.

12. The method of claim 11, further comprising creating noise abatement structures around the private automobile racetrack using material excavated during creation of the artificial lake.

13. The method of claim 4, wherein the residences comprise privately owned or fractionally owned condominiums.

14. The method of claim 4, wherein the residences comprise single-family residences.

15. The method of claim 14, wherein the single-family residences are limited to eight in number.

16. The method of claim 4, wherein the private housing comprises a privately owned hotel.

17. The method of claim 4, further comprising providing a nature preserve.

18. The method of claim 4, further comprising providing trees to mitigate noise generated by automobiles driven on the automobile racetrack.

19. A method for operating an automobile racetrack, comprising:
providing a private automobile racetrack comprising a paved track designed to accommodate high-speed driving of high performance automobiles;
selling parcels of land surrounding the private automobile racetrack, wherein private residences are built on the parcels of land; and
fractionally dividing ownership of the private automobile racetrack between owners of the private residences.

20. The method of claim 19, further comprising funding maintenance and improvement of the private automobile racetrack through contributions by the owners.
